(19) United States
(12) Patent Application Publication
(10) Pub. No.: US 2009/0290560 A1
(43) Pub. Date: Nov. 26, 2009

(54) METHOD AND BASE STATION FOR UPLINK RESOURCE ALLOCATION IN TIME-SHARING CHANNEL MODE

(75) Inventor: Shulan Feng, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/511,684

(22) Filed: Jul. 29, 2009

Related U.S. Application Data
(63) Continuation of application No. PCT/CN2007/070940, filed on Oct. 22, 2007.

(30) Foreign Application Priority Data
Feb. 2, 2007 (CN) 200710003276.5
Feb. 15, 2007 (CN) 200710080261.9

(51) Int. Cl. H04J 3/00

(52) U.S. Cl. 370/336

(57) ABSTRACT

A method for uplink resource allocation in a time-sharing channel mode is provided. The method includes the following steps. A base station accesses a network, and receives an uplink resource selection notification message from a neighboring base station, in which the uplink resource selection notification message carries information of uplink resources selected by the neighboring base station; and the base station initially accessing the network allocates uplink resources that do not overlap the uplink resources selected by the neighboring base station. A base station for uplink resource allocation in a time-sharing channel mode is also provided. By using such method and base station, different uplink resources are allocated to different base stations, so as to prevent possible conflict among one another, and avoid repeatedly transmitting the same signaling, thereby saving the resources.

### CROSS-REFERENCE TO RELATED APPLICATIONS

This application is a continuation of International Application No. PCT/CN2007/070940, filed on Oct. 22, 2007, which claims priority to Chinese Patent Application Nos. 200710003276.5, filed on Feb. 2, 2007 and 200710080261.9, filed on Feb. 15, 2007. The contents of the above identified applications are incorporated herein by reference in their entireties.

### FIELD OF THE TECHNOLOGY

The disclosure relates to wireless communication technology, and more particularly to a method and a base station for uplink resource allocation in a time-sharing channel mode.

### BACKGROUND

The continuous development of the wireless communication technology raises higher requirements for the radio spectrum. However, the current spectrum resources are limited, so that the utilization of the radio spectrum, especially the utilization of the authorized frequency bands, is required to be improved. In recent years, the cognitive radio technology has been proposed. Wireless devices supporting the cognitive radio technology can dynamically sense the changes in the surrounding environment, and adaptively adjust the internal state thereof according to the changes in the environment, so as to effectively make use of the idle spectrum, thereby preventing interferences on other systems, especially on authorized users. However, the idle spectrum resources are also limited, so the wireless devices are required to time-share the same channel with other devices. The time sharing may be performed in various different modes, for example, time-sharing the channel based on asynchronous carrier sense/collision detection, or based on synchronous collaboration.

In the prior art, a time-sharing mode of a channel based on synchronous collaboration has been disclosed. According to this mode, a media access control (MAC) frame is divided into two parts, one is a common sub-frame, used to transmit data that is not interfered with in the system; and the other is an interference sub-frame, used to transmit data that is interfered. The interference sub-frame is allocated to a specific system uniquely and periodically. In this case, the interference sub-frame is referred to as a master sub-frame of the system. A system transmits data at the maximum power by the master sub-frame of the system, and other systems are required to reduce their transmission power or even stop transmitting at this time, so as to avoid causing interferences on the system using the master sub-frame. The master sub-frame is also referred to as a secondary sub-frame of neighboring systems. A common sub-frame may be a part of a MAC frame, or occupy a complete MAC frame. When the common sub-frame occupies a complete frame, the common sub-frame is also referred to as a shared sub-frame. The common sub-frame and the interference sub-frame may be allocated in various different modes.

FIG. 1 is a schematic structural view of two systems interfering with each other in the prior art. As shown in FIG. 1, a system A includes a base station A, a terminal 1, a terminal 2, and a terminal 3, and a system B includes a base station B, a terminal 4, a terminal 5, and a terminal 6. Though the terminal 3 accesses the system A, it is also in the coverage of the base station B, so the terminal 3 is interfered by the base station B. Meanwhile, the terminal 3 also generates interferences on the base station B as well. The interference situation of the terminal 4 is similar to that of the terminal 3. FIG. 2 is a schematic view of data transmission for the systems in FIG. 1 in a time-sharing MAC frame mode. In time-sharing mode, the system A transmits data related to the terminal 1 and the terminal 2 by the common sub-frames, and the system B transmits data related to the terminal 5 and the terminal 6 by the common sub-frames. By the master sub-frame of the system A, that is, the secondary sub-frame of the system B, the system A transmits data related to the terminal 3, and at this time, the system B reduces the transmission power or stops transmitting, so as to not cause interferences on the system A. Correspondingly, by the next MAC frame, the master sub-frame of the system B, that is, the secondary sub-frame of the system A, the system B transmits the data related to the terminal 4, and at this time, the system A reduces the transmission power or stops transmitting, so as to prevent causing interferences on the system B. FIG. 2 merely shows the time-sharing mode of a downlink channel. The time-sharing mode of an uplink channel is similar to that of the downlink channel, and is not described again here.

However, in such time-sharing channel mode, when the terminals in the common coverage, for example, the terminal 3 and the terminal 4 in FIG. 1, perform an uplink ranging, an uplink ranging request signal sent by either terminal may be received by two neighboring base stations at the same time, and the two base stations may both respond to the uplink ranging request at the same time and correspondingly allocate uplink ranging resources for the uplink ranging request, which causes the waste and conflict of resources.

### SUMMARY

The disclosure is directed to a method for uplink resource allocation in a time-sharing channel mode, which is capable of preventing waste and conflict of resources.

The disclosure is directed to a base station for uplink resource allocation in a time-sharing channel mode, which is capable of preventing waste and conflict of resources.

The technical solutions according to embodiments of the disclosure are achieved as follows.

A method for uplink resource allocation in a time-sharing channel mode is provided, which includes the following steps.

A base station accesses a network, and receives an uplink resource selection notification message from a neighboring base station, in which the uplink resource selection notification message carries information of uplink resources selected by the neighboring base station.

The base station initially accessing the network allocates uplink resources that do not overlap the uplink resources selected by the neighboring base station.

A base station for uplink resource allocation in a time-sharing channel mode is provided. The base station includes a detection module, a resource selection notification module, and an uplink resource allocation module.

The detection module is adapted to detect whether a neighboring base station exists in a network.

The resource selection notification module is adapted to receive the detection result from the detection module, and receive an uplink resource selection notification message from the neighboring base station, and notify uplink resources selected by the neighboring base station to the uplink resource allocation module.

The uplink resource allocation module is adapted to receive a notification message from the resource selection notification module, and allocate uplink resources that do not overlap the uplink resources selected by the neighboring base station according to the notification message.

Therefore, by using the technical solutions according to the embodiments of the disclosure, the base stations in a network obtain uplink resources that do not overlap one another through negotiation. Thus, the base stations transmit signaling in their respective uplink resources, so as to prevent possible conflicts among one another, and avoid repeatedly responding to the same signaling, thereby saving the resources.

### BRIEF DESCRIPTION OF THE DRAWINGS

A detailed description of embodiments according to the disclosure is given below with accompanying drawings so that those skilled in the art more fully understand the above and other characteristics and advantages of the disclosure, and in which

FIG. 1 is a schematic structural view of two systems interfering with each other in the prior art;

FIG. 2 is a schematic view of data transmission performed by the systems in FIG. 1 in a time-sharing MAC frame mode;

FIG. 3 is a schematic structural view of a base station according to an embodiment of the disclosure;

FIG. 4 is a general flow chart of a method according to an embodiment of the disclosure; and

FIG. 5 is a flow chart of a method according to a preferred embodiment of the disclosure.

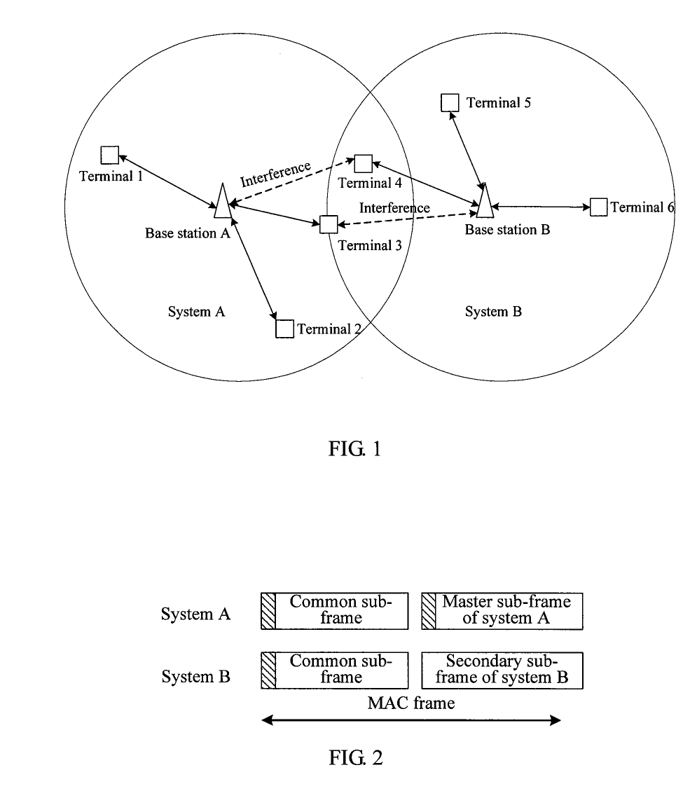

### DETAILED DESCRIPTION

In the embodiments of the disclosure, base stations negotiate with one another of the allocation of shared resources, and allocate uplink resources according to a negotiation result.

To make the objectives, technical solutions, and beneficial effects of the disclosure more comprehensible, the disclosure is described in detail below with reference to the accompanying drawings and embodiments.

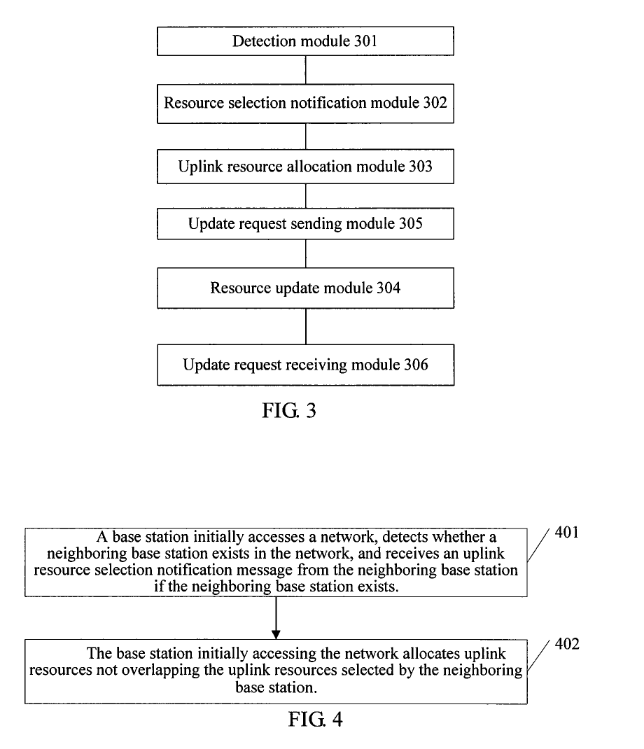

FIG. 3 is a schematic structural view of a base station according to an embodiment of the disclosure. As shown in FIG. 3, the base station includes a detection module 301, a resource selection notification module 302, and an uplink resource allocation module 303.

The detection module 301 is adapted to detect whether a neighboring base station exists in a network, and send a detection result to the resource selection notification module 302.

The resource selection notification module 302 is adapted to receive the detection result from the detection module 301. When no neighboring base station exists, the resource selection notification module 302 is adapted to notify the uplink resource allocation module 303 that no neighboring base station exists in the network. When any neighboring base station exists in the network, the resource selection notification module 302 is adapted to receive an uplink resource selection notification message from the neighboring base station and notify uplink resources selected by the neighboring base station to the uplink resource allocation module 303.

The uplink resource allocation module 303 is adapted to receive a notification message from the resource selection notification module 302, and allocate uplink resources according to the notification message, that is, allocate uplink resources different from the uplink resources selected by the neighboring base station when the neighboring base station exists, or allocate uplink resources according to the demand of itself when no neighboring base station exists.

The base station further includes a resource update module 304 and an update request sending module 305.

The resource update module 304 is adapted to receive an uplink resource setting update request from the update request sending module 305, judge whether updated uplink resource setting conflicts with uplink resource setting of the neighboring base station, and notify the updated uplink resource setting to the neighboring base station if no conflict occurs, or send an uplink resource setting update request to the neighboring base station, when a conflict occurs, and send a response message received from the neighboring base station to the update request sending module 305.

The update request sending module 305 is adapted to send the uplink resource setting update request to the resource update module 304, and notify the uplink resource allocation module 303 to update or maintain an original uplink resource setting according to the response message from the neighboring base station sent by the resource update module. Particularly, if the response message indicates that the neighboring base station agrees to release the uplink resources thereof, the update request sending module 305 notifies the uplink resource allocation module 303 to update the original uplink resource setting; if the response message indicates that the neighboring base station does not agree to release the uplink resources thereof, the update request sending module 305 notifies the uplink resource allocation module 303 to maintain the original uplink resource setting.

The base station further includes an update request receiving module 306. The update request receiving module 306 is adapted to receive the uplink resource setting update request from the neighboring base station, and returns a response message of whether the base station agrees to release the uplink resources thereof to the neighboring base station.

If a base station fails to update the uplink resource setting thereof when it requests to update the uplink resource setting, the base station may continue to initiate an update request later on. For example, the base station requests to add two timeslots when it requests to update the uplink resource setting for the first time, but the neighboring base station does not agree. In this case, subsequently, the base station may maintain the original uplink resource setting, or initiate an uplink resource setting update request, for example, the base station requests to add only one timeslot this time. The subsequent process is the same as that for requesting to update the uplink resource setting for the first time, and will not be described again here.

FIG. 4 is a general flow chart of a method according to an embodiment of the disclosure, based on the base station equipment described above. As shown in FIG. 4, the method includes the following steps.

In Step 401, the base station initially accesses a network, detects whether a neighboring base station exists in the network, and receives an uplink resource selection notification message from the neighboring base station if the neighboring base station exists.

The uplink resource selection notification message carries information of uplink resources selected by the neighboring base station. For example, if the resource sharing mode of time-sharing a MAC frame shown in FIG. 2 is adopted, the uplink resource selection notification message in this step carries information of a master sub-frame selected by the neighboring base station.

The base station initially accessing the network exchanges information with the neighboring base station through the following manners to obtain the required information. The base station initially accessing the network acquires whether any neighboring base station exists and the location of the neighboring base station by querying a database, after that, sends a request message requesting to obtain information of the uplink resources selected by the neighboring base station, then the neighboring base station returns an uplink resource selection notification message. Alternatively, the base station sends a broadcast message to neighboring base stations in the network when the base station initially accesses the network, and the neighboring base stations gets to know that a new base station accesses the network through the broadcast message, and sends an uplink resource selection notification messages to the base station. The above manners fall within the prior art, and will not be described in detail here.

In Step 402, the base station initially accessing the network allocates uplink resources that do not overlap the uplink resources selected by the neighboring base station.

In this step, the base station initially accessing the network allocates the uplink resources thereof according to the result of Step 401. If a detection result indicates that no neighboring base station exists in the network, the base station initially accessing the network allocates the uplink resources according to the demand thereof. If the detection result indicates that a neighboring base station exists in the network, the base station initially accessing the network allocates uplink resources different from the uplink resources selected by the neighboring base station in Step 401. Optionally, the base station initially accessing the network notifies the uplink resources selected by the base station itself to the neighboring base station.

Correspondingly, if the resource sharing mode of time-sharing a MAC frame shown in FIG. 2 is adopted, the base station initially accessing the network allocates the uplink resources different from the uplink resources selected by the neighboring base station through the following manners. The base station initially accessing the network selects a sub-frame different from that selected by the neighboring base station as a master sub-frame thereof, and allocates the uplink resources only by the master sub-frame thereof and does not allocate the uplink resources by the common sub-frame and the secondary sub-frame. Alternatively, the base station initially accessing the network allocates the uplink resources only in a region without interferences corresponding to a terminal. Particularly, as for a terminal in a common coverage, the base station initially accessing the network allocates the uplink resources only by the master sub-frame thereof, and as for a terminal that is not interfered with by the neighboring system nor interferes with the neighboring system, the base station initially accessing the network allocates the uplink resources by the master sub-frame or the common sub-frame.

Furthermore, when any base station in the network needs to update an uplink resource setting thereof, for example, a base station intends to add uplink resources on the basis of the uplink resources selected currently due to the data transmission requirements, the base station needs to judge whether the updated uplink resource setting thereof conflicts with an uplink resource setting of the neighboring base station at first. If no conflict occurs, the base station only needs to notify the updated uplink resource setting to the neighboring base station; if a conflict occurs, the base station needs to send an uplink resource setting update request to the neighboring base station. If a message indicating that the neighboring base station agrees to release the uplink resources thereof sent by the neighboring base station is received after the request is sent, the base station updates the uplink resource setting thereof, if the neighboring base station does not agree to release the uplink resources thereof, the base station cannot update the uplink resource setting, but maintain the original uplink resource setting thereof, or the base station can further initiate a new process of updating the uplink resource setting thereof.

The uplink resources are uplink initial ranging resources, or as for the physical layer of a wireless metropolitan area network orthogonal frequency division multiple access (wireless MAN-OFDMA), the uplink resources are uplink initial ranging resources, uplink periodic ranging resources, and uplink handover ranging resources.

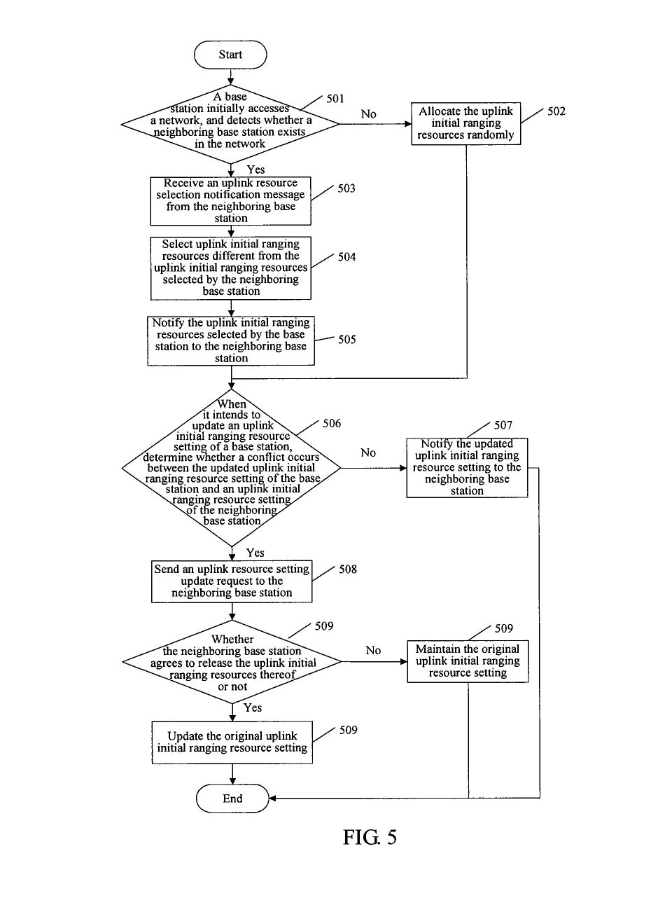

Another embodiment is given below to describe the method of the disclosure in further detail. FIG. 5 is a flow chart of a method according to the embodiment of the disclosure. In this embodiment, the uplink resources are uplink initial ranging resources, as shown in FIG. 5. The method includes the following steps.

In Step 501, a base station initially accesses a network, and detects whether a neighboring base station exists in the network; if no neighboring base station exists in the network, Step 502 is performed; otherwise, Step 503 is performed.

In Step 502, the base station initially accessing the network allocates the uplink initial ranging resources thereof according to a demand thereof.

If the base station intends to update the uplink initial ranging resource setting later on, Step 506 is performed.

In Step 503, the base station initially accessing the network receives an uplink resource selection notification message from the neighboring base station.

If any neighboring base station exists in the network, it indicates that the current base station initially accessing the network needs to time-share the channel resources with the neighboring base station, so the base station initially accessing the network exchanges information with the neighboring base station to receive the uplink resource selection notification message from the neighboring base station, and acquires the uplink initial ranging resources selected by the neighboring base station through the message.

If the resource sharing mode of time-sharing a MAC frame shown in FIG. 2 is adopted, the uplink resource selection notification message in this step carries information of a master sub-frame selected by the neighboring base station.

In Step 504, the base station initially accessing the network selects uplink initial ranging resources different from the uplink initial ranging resources selected by the neighboring base station.

In Step 505, the base station initially accessing the network notifies the uplink initial ranging resources selected by the base station to the neighboring base station.

In Step 506, if any base station in the network needs to update the uplink initial ranging resource setting thereof, firstly, it is judged whether the updated uplink initial ranging resource setting conflicts with uplink initial ranging resource setting of the current neighboring base station; if no conflict occurs, Step 507 is performed; otherwise, Step 508 is performed.

In Step 507, the base station that needs to update the uplink initial ranging resource setting notifies the updated uplink initial ranging resource setting to the neighboring base station, and the process ends.

In Step 508, the base station that needs to update the uplink initial ranging resource setting sends an uplink resource setting update request to the neighboring base station, in which the request message carries the updated uplink initial ranging resource setting.

In Step 509, the neighboring base station returns a response message to the base station that needs to update the uplink initial ranging resource setting. If the neighboring base station does not agree to release the uplink initial ranging resources thereof, the base station that needs to update the uplink initial ranging resource setting can not update the uplink initial ranging resource setting, but maintain the original uplink initial ranging resource setting, and the process ends; and if the neighboring base station agrees to release the uplink initial ranging resources thereof, the base station that needs to update the uplink initial ranging resource setting updates the original uplink initial ranging resource setting, and the process ends.

The process for implementing the method for uplink resource allocation by the base stations in the time-sharing MAC frame mode is similar to the process shown in FIG. 5. The difference there-between lies in that, the base stations allocate the uplink resources in their respective master sub-frames or merely in the corresponding master sub-frame and common sub-frame. The selection of the respective master sub-frames and the operation for updating the respective master sub-frame setting are the same as the process shown in FIG. 5, and will not be described again here.

Therefore, by using the technical solutions according to the embodiments of the disclosure, the base stations in a network obtain uplink resources that do not overlap one another through negotiation. Thus, the base stations transmit signaling in their respective uplink resources, so as to prevent possible conflicts among one another, and avoid repeatedly responding to the same signaling, thereby saving the resources.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

What is claimed is:

1. A method for uplink resource allocation in a time-sharing channel mode, comprising:
accessing, by a base station, and receiving an uplink resource selection notification message from a neighboring base station, wherein the uplink resource selection notification message carries information of uplink resources selected by the neighboring base station; and
allocating, by the base station initially accessing a network, uplink resources that do not overlap the uplink resources selected by the neighboring base station.

2. The method according to claim 1, wherein the time-sharing channel mode is a time-sharing media access control (MAC) frame mode, and the information of the uplink resources selected by the neighboring base station is information of a master sub-frame selected by the neighboring base station.

3. The method according to claim 1, wherein the allocating, by the base station initially accessing the network, the uplink resources that do not overlap the uplink resources selected by the neighboring base station comprises:
selecting, by the base station initially accessing the network, a sub-frame different from the sub-frame selected by the neighboring base station as a master sub-frame of the base station; and allocating the uplink resources by the master sub-frame of the base station, or allocating the uplink resources by the master sub-frame of the base station or during a common sub-frame.

4. The method according to claim 1, further comprising: notifying, by the base station initially accessing the network, the uplink resources selected by the base station to the neighboring base station.

5. The method according to claim 1, further comprising:
if any base station in the network needs to update an uplink resource setting thereof, judging, by the base station, whether an updated uplink resource setting conflicts with an uplink resource setting of the neighboring base station;
notifying, by the base station, the updated uplink resource setting to the neighboring base station if no conflict occurs; sending, by the base station, an uplink resource setting update request to the neighboring base station if the conflict occurs, wherein if a message indicating that the neighboring base station agrees to release the uplink resources thereof returned by the neighboring base station is received, the base station updates the uplink resource setting thereof, or if a message indicating that the neighboring base station does not agree to release the uplink resources thereof returned by the neighboring base station is received, the base station maintains an original uplink resource setting or initiates a new process for updating the uplink resource setting thereof.

6. The method according to claim 1, wherein
the uplink resources are uplink initial ranging resources; or
the uplink resources are uplink initial ranging resources, uplink periodic ranging resources, and uplink handover ranging resources.

7. A base station for uplink resource allocation in a time-sharing channel mode, comprising: a detection module, a resource selection notification module, and an uplink resource allocation module; wherein
the detection module is adapted to detect whether a neighboring base station exists in a network;
the resource selection notification module is adapted to get the detection result from the detection module; and get an uplink resource selection notification message from the neighboring base station, and notify uplink resources selected by the neighboring base station to the uplink resource allocation module; and
the uplink resource allocation module is adapted to get a notification message from the resource selection notification module, and allocate uplink resources that do not overlap the uplink resources selected by the neighboring base station according to the notification message.

8. The base station according to claim 7, wherein the uplink resource allocation module is further adapted to allocate the uplink resources according to a demand of the uplink resource allocation module if the resource selection notification module notifies that no neighboring base station exists in the network.

9. The base station according to claim 7, further comprising: a resource update module and an update request sending module, wherein
the resource update module is adapted to receive an uplink resource setting update request from the update request sending module; judge whether an updated uplink resource setting conflicts with an uplink resource setting of the neighboring base station; and notify the updated uplink resource setting to the neighboring base station if no conflict occurs, or send an uplink resource setting update request to the neighboring base station if the conflict occurs and send a response message received from the neighboring base station to the update request sending module; and
the update request sending module is adapted to send the uplink resource setting update request to the resource update module, and notify the uplink resource allocation module to update or maintain an original uplink resource setting according to the response message from the neighboring base station sent by the resource update module, wherein if the response message indicates that the neighboring base station agrees to release the uplink resources thereof, the update request sending module notifies the uplink resource allocation module to update the original uplink resource setting; and if the response message indicates that the neighboring base station does not agree to release the uplink resources thereof, the update request sending module notifies the uplink resource allocation module to maintain the original uplink resource setting.

10. The base station according to claim 9, further comprising: an update request receiving module, adapted to receive an uplink resource setting update request from the neighboring base station, and return a response message indicating whether the base station agrees to release the uplink resources of the base station to the neighboring base station.
